(19) United States
(12) Patent Application Publication
(10) Pub. No.: US 2025/0253311 A1
(43) Pub. Date: Aug. 7, 2025

(54) SOLID-STATE BATTERY AND METHOD FOR PRODUCING SOLID-STATE BATTERY

(71) Applicant: TOYOTA JIDOSHA KABUSHIKI KAISHA, Toyota-shi (JP)

(72) Inventors: Ryo ASAKURA, Sunto-gun (JP); Shinya SHIOTANI, Nagoya-shi (JP)

(73) Assignee: TOYOTA JIDOSHA KABUSHIKI KAISHA, Toyota-shi (JP)

(21) Appl. No.: 19/023,838

(22) Filed: Jan. 16, 2025

(30) Foreign Application Priority Data
Feb. 2, 2024 (JP) 2024-014612

(51) Int. Cl. H01M 4/134; H01M 4/02; H01M 10/04; H01M 10/0562; H01M 50/105

(52) U.S. Cl. CPC H01M 4/134; H01M 10/0468; H01M 10/0562; H01M 50/105; H01M 2004/021; H01M 2004/028; H01M 2300/0068

(57) ABSTRACT

To provide a solid-state battery configured to suppress a short circuit and a method for producing the solid-state battery. A solid-state battery, wherein the solid-state battery comprises a cathode layer, an anode layer, and a solid electrolyte layer disposed between the cathode layer and the anode layer; wherein the anode layer comprises at least one of a lithium metal or a lithium alloy; wherein a ratio of a thickness of the solid electrolyte layer to a thickness of the anode layer is 0.65 or more and 0.77 or less; and wherein a filling rate of the solid electrolyte layer is 82.3% or more.

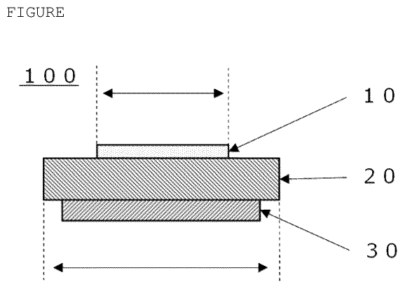

### TECHNICAL FIELD

The disclosure relates to a solid-state battery and a method for producing the solid-state battery.

### BACKGROUND

Various studies have been proposed for a solid-state battery as disclosed in Patent Documents 1 and 2.
Patent Document 1: Japanese Patent Application Laid-Open (JP-A) No. 2018-206469
Patent Document 2: JP-A No. 2019-179604

To improve the energy-density of solid-state batteries, a solid-state battery in which the anode contains a Li element, has been developed.

Patent Document 1 discloses that a short circuit of a solid-state battery is suppressed by paying attention to an interface between the solid electrolyte layer and cathode layer. However, the relation between the solid electrolyte layer and the anode layer still causes a short circuit of the solid-state battery.

### SUMMARY

The present disclosure was achieved in light of the above circumstances. An object of the present disclosure is to provide a solid-state battery configured to suppress a short circuit and a method for producing the solid-state battery.

The present disclosure includes the following embodiments.

### <1> A Solid-State Battery,

wherein the solid-state battery comprises a cathode layer, an anode layer, and a solid electrolyte layer disposed between the cathode layer and the anode layer;
wherein the anode layer comprises at least one of a lithium metal or a lithium alloy;
wherein a ratio of a thickness of the solid electrolyte layer to a thickness of the anode layer is 0.65 or more and 0.77 or less; and
wherein a filling rate of the solid electrolyte layer is 82.3% or more.
   <2> The solid-state battery according to <1>, wherein the thickness of the anode layer is 100 μm or less.
   <3> The solid-state battery according to <1> or <2>, wherein the thickness of the solid electrolyte layer is 65 μm or more.
   <4> A method for producing a solid-state battery comprising a cathode layer, an anode layer, and a solid electrolyte layer disposed between the cathode layer and the anode layer,
the method comprising:
obtaining a stack by disposing the solid electrolyte layer between the anode layer and the cathode layer, and
vacuum-sealing the stack with a laminate film and pressing them,
wherein the anode layer comprises at least one of a lithium metal or a lithium alloy;
wherein a ratio of a thickness of the solid electrolyte layer to a thickness of the anode layer is 0.65 or more and 0.77 or less; and
wherein a filling rate of the solid electrolyte layer is 82.3% or more.
   <5> The method for producing a solid-state battery according to <4>,
wherein a pressing pressure of the pressing is 400 MPa or less.

According to the present disclosure, a solid-state battery configured to suppress a short circuit and a method for producing the solid-state battery can be provided.

### BRIEF DESCRIPTION OF THE DRAWING

The FIGURE is a schematic cross-sectional view of an example of the solid-state battery of the present disclosure.

### DETAILED DESCRIPTION

Hereinafter, the embodiments of the present disclosure will be described in detail. Matters that are required to implement the present disclosure (such as common solid-state battery structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In the present disclosure, unless otherwise noted, the average particle diameter of the particles is the value of a median diameter (D50) which is a particle diameter at an accumulated value of 50% in a volume-based particle size distribution measured by laser diffraction and scattering particle size distribution measurement.

### 1. Solid-State Battery

According to the present disclosure, there is provided a solid-state battery,
wherein the solid-state battery comprises a cathode layer, an anode layer, and a solid electrolyte layer disposed between the cathode layer and the anode layer;
wherein the anode layer comprises at least one of a lithium metal or a lithium alloy;
wherein a ratio of a thickness of the solid electrolyte layer to a thickness of the anode layer is 0.65 or more and 0.77 or less; and
wherein a filling rate of the solid electrolyte layer is 82.3% or more.

Since lithium-metal or lithium-alloy is softer than other anode materials, the anode layer penetrate the solid electrolyte layer, penetrate the solid electrolyte layer, reach cathode, and short-circuit the solid electrolyte layer during pressurization or restraint for reducing the resistivity at the interface between the solid electrolyte layer and anode layer in the solid-state battery. Although it is conceivable to increase the thickness of the solid electrolyte layer in order to prevent a short circuit, the volume energy density of the solid-state battery decreases.

According to the present disclosure, it is possible to reduce the number of the anode layer that penetrate into the solid electrolyte layer during pressing or restraint without lowering the volume-energy-density of the solid-state battery by defining the ratio of the filling rate of the solid electrolyte layer to the thickness of anode layer.

A solid-state battery includes a cathode including a cathode layer, an anode including an anode layer, and a solid electrolyte layer disposed between cathode layer and anode layer.

In the present disclosure, a solid-state battery means a battery including a solid electrolyte. The solid-state battery may be a semi-solid-state battery that is a solid-state battery including a solid electrolyte and a liquid-based material, or may be an all-solid-state battery that is a solid-state battery that does not include a liquid-based material.

When the cathode, the solid electrolyte layer, and the anode are set as power generation units, the solid-state battery may have only one power generation unit or two or more power generation units.

When the solid-state battery has two or more power generation units, the power generation units may be connected in series or in parallel.

When the solid-state battery is viewed from cathode layer, the area of cathode layer may be smaller than or the same as the area of the solid electrolyte layer.

When the solid-state battery is viewed from anode layer, the area of anode layer may be smaller than or the same as the area of the solid electrolyte layer.

The area of cathode layer and the area of anode layer may be the same or different, and the area of cathode layer may be smaller than the area of anode layer from the viewpoint of suppressing the deposition of Li metallic dendrites.

When the solid-state battery is viewed from the cathode layer, the solid electrolyte layer may extend from all the outer edges of the cathode layer toward the outer side of the cathode layer.

When the solid-state battery is viewed from the anode layer, the solid electrolyte layer may extend from all the outer edges of the anode layer toward the outer side of the anode layer.

The FIGURE is a schematic cross-sectional view of an example of the solid-state battery of the present disclosure.

The solid-state battery 100 includes a cathode layer 10, an anode layer 30, and a solid electrolyte layer 20 disposed between cathode layer 10 and anode layer 30.

In the solid-state battery 100, the area of the stack surface of the cathode layer 10 is smaller than the area of the laminated surface of the solid electrolyte layer 20, the area of the laminated surface of the anode layer 30 is smaller than the area of the laminated surface of the solid electrolyte layer 20, and the area of the laminated surface of the cathode layer 10 is smaller than the area of the laminated surface of the anode layer 30.

The solid-state battery includes, as required, a cathode layer, an anode layer, and an exterior body that houses a solid electrolyte layer and the like.

The material of the exterior body is not particularly limited as long as it is stable in the solid electrolyte, and examples thereof include metals such as aluminum, polypropylene, polyethylene, and resins such as acrylic resin.

As the shape of the solid-state battery, for example, coin-type, laminate-type, cylindrical, and square-type, and the like.

The solid-state battery may be a primary battery or a secondary battery. Applications of solid-state battery include, for example, power supplies for vehicles such as hybrid vehicles (HEV), plug-in hybrid vehicles (PHEV), electric vehicles (BEV), gasoline-powered vehicles, diesel-powered vehicles, and the like.

Among them, it may be used as a power source for driving a hybrid vehicle (HEV), a plug-in hybrid vehicle (PHEV), or an electric vehicle (BEV). Further, the solid-state battery may be used as a power source for a moving object (for example, a railway, a ship, an aircraft, or the like) other than the vehicle, or may be used as a power source for an electric product such as an information processing apparatus.

### [Thickness of Solid Electrolyte Layer/Anode Layer]

The thickness of the solid electrolyte layer relative to the thickness of the anode layer is not less than 0.65 and not more than 0.77.

Within this range, a short circuit of the solid-state battery can be suppressed without lowering the volume energy density of the solid-state battery.

### [Cathode]

The cathode includes a cathode layer. The cathode optionally includes a cathode current collector.

### [Cathode Layer]

The cathode layer may include a cathode active material, and may optionally include a solid electrolyte, a conductive material, a binder, and the like.

Examples of the cathode active material include sulfur alone, a sulfur mixture of sulfur and carbon, phosphorus, lithium, and the like, lithium nickel cobalt aluminum oxide (NCA), LiCOO₂, LiNiₓCo₁₋ₓO₂ (0<x<1), LiNi_{1/3}CO_{1/3}Mn_{1/3}O₂, LiMnO₂, LiMn₂O₄, LiNiO₂, LiVO₂, heterogeneous element-substituted Li—Mn spinel, lithium titanate, metallic lithium phosphate, LiCON, Li₂SiO₃, and Li₄SiO₄. Examples of the heterogeneous element-substituted Li—Mn spinel include LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄. The lithium titanate is, for example, Li₄Ti₅O₁₂ or the like. Examples of the metallic lithium phosphate include LiFePO₄, LiMnPO₄, LiCoPO₄, and LiNiPO₄.

The form of the cathode active material is not particularly limited, but may be a particulate form (cathode active material particles). The mean particle size of cathode active material grains is not particularly limited, and may be in 1 nm of 100 micrometers.

Cathode active material may include a Li ion-conductive compound. This is because cathode active material and the solid electrolyte can be suppressed from reacting with each other. Examples of Li ion-conductive compound include LiNbO₃, Li₄Ti₅O₁₂, and Li₃PO₄. The thickness of the coating layer is, for example, 0.1 nm or more, and may be 1 nm or more. On the other hand, the thickness of the coating layer may be, for example, less than or equal to 100 nm and less than or equal to 20 nm. The coating ratio of the coating layer on the surface of cathode active material is, for example, 70% or more, and may be 90% or more.

As the conductive material, known materials can be used, and examples thereof include a carbon material and metal particles. Examples of the carbon material include acetylene black (AB), furnace black, VGCF, carbon nanotubes, and carbon nanofibers. Among them, from the viewpoint of electronic conductivity, it may be at least one selected from the group consisting of VGCF, carbon nanotubes, and carbon nanofibers. The metallic particles include particles such as Ni, Cu, Fe, and SUS.

The content of the conductive material in the cathode layer is not particularly limited.

Examples of the solid electrolyte include inorganic solid electrolyte such as sulfide solid electrolyte, oxide solid electrolyte, hydride solid electrolyte, halide solid electrolyte, and nitride solid electrolyte, as well as organic polymer electrolyte such as polymer electrolyte. From the viewpoint of suppressing the separation of the cathode layer and the anode layer from the solid electrolyte layer and further reducing the resistivity of the solid-state battery, a relatively soft sulfide solid electrolyte may be used as the solid electrolyte. Only one type of solid electrolyte may be used alone, or two or more types of solid electrolyte may be used in combination.

Examples of the sulfide solid electrolyte include a solid electrolyte including an Li element, an element A, and an element S. Element A is at least one of P, As, Sb, Si, Ge, Sn, B, Al, Ga, and In. The sulfide solid electrolyte may further contain at least one of an O element and a halogen element. The halogen element (X), for example, F element, Cl element, Br element, and I elements and the like. The sulfide solid electrolyte may be glass (amorphous), glass ceramics, or crystalline. When the sulfide solid electrolyte is a crystalline, the sulfide solid electrolyte has a crystalline phase. Examples of the crystalline phase include a Thio-LISICON crystalline phase, a LGPS crystalline phase, and an aldilodite crystalline phase. Examples of the sulfide solid electrolyte include Li₂S—P₂S₅, LiI—Li₂S—P₂S₅, LiI—LiBr—Li₂S—P₂S₅, Li₂S—SiS₂, Li₂S—GeS₂, and Li₂S—P₂S₅—GeS₂. Note that the description of “Li₂S—P₂S₅” means a material using a raw material composition containing Li₂S and P₂S₅, and the same applies to other descriptions. The molar ratio of each element in the sulfide solid electrolyte can be controlled by adjusting the content of each element in the raw material. In addition, the molar ratio and the composition of the respective elements in the sulfide solid electrolyte can be measured, for example, by ICP emission spectrometry.

Examples of the oxide solid electrolyte include a solid electrolyte containing an Li element, a Z element (Z is at least one of Nb, B, Al, Si, P, Ti, Zr, Mo, W, and S), and an O element. The oxide solid electrolyte may be, for example, Li₂O—B₂O₃—P₂O₅, Li₂O—SiO₂, Li₂O—B₂O₃, Li_{1.3}Al_{0.3}Ti_{0.7} (PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄, or Li₃₊ₓPO₄₋ₓNₓ (1≤x≤3).

The hydride solid electrolyte has, for example, Li and hydrogen-containing complex anions. Examples of the complex anion include (BH₄)⁻, (NH₂)⁻, (AlH₄)⁻, and AlH₆)³⁻).

Examples of the halogenated solid electrolyte include LiF, LiCl, LiBr, LiI, and LiI—Al₂O₃.

Examples of the nitrogenated solid electrolyte include Li₃N and the like.

The solid electrolyte may be solid electrolyte particles.

The mean particle diameter (D50) of the solid electrolyte particles is not particularly limited, but may be 0.1 μm or more and 100 μm or less.

The content of the solid electrolyte in the cathode layer is not particularly limited, but may be, for example, 1% by mass to 80% by mass when the total mass of cathode layer is taken as 100% by mass.

Examples of the binder include a rubber-based binder and a fluoride-based binder. Examples of the rubber-based binder include butadiene rubber, hydrogenated butadiene rubber, styrene butadiene rubber (SBR), hydrogenated styrene butadiene rubber, nitrile butadiene rubber, hydrogenated nitrile butadiene rubber, acrylonitrile butadiene rubber (ABR), and ethylene propylene rubber. Examples of the fluorine-based binder include polyvinylidene fluoride (PVDF), polyvinylidene fluoride-polyhexafluoropropylene copolymer (PVDF-HFP), polytetrafluoroethylene, and fluororubber.

The content of the binder in the cathode layer is not particularly limited.

The thickness of the cathode layer is not particularly limited.

The cathode layer can be formed by conventionally known methods.

For example, a cathode slurry is prepared by charging a cathode active material and, if desired, other components into solvents and agitating, and cathode slurry is applied onto one surface of a support such as a cathode current collector and dried to obtain the cathode layer.

Solvents include, for example, butyl acetate, butyl butyrate, heptane, and N-methyl-2-pyrrolidone.

A method of applying cathode slurry on one surface of a support such as a cathode current collector is not particularly limited, and examples thereof include a doctor blade method, a metal mask printing method, an electrostatic coating method, a dip coating method, a spray coating method, a roll coating method, a gravure coating method, and a screen printing method.

As the support, one having a self-supporting property can be appropriately selected and used, and there is no particular limitation, and for example, metallic foils such as Cu and Al can be used.

### [Cathode Current Collector]

As cathode current collector, a known metallic material that can be used as a current collector of a solid-state battery can be used. Examples of such metals include metal materials containing one or more elements selected from the group consisting of Cu, Ni, Al, V, Au, Pt, Mg, Fe, Ti, Co, Cr, Zn, Ge, and In. Examples of cathode current collector include SUS, aluminum, nickel-iron, titanium-carbon, and the like.

The form of cathode current collector is not particularly limited, and may be various forms such as a foil form and a mesh-form form.

### [Anode]

The anode includes an anode layer. The anode optionally includes an anode current collector.

### [Anode Layer]

The anode layer comprises an anode active material. The anode layer may optionally contain at least one of a solid electrolyte, a conductive material, and a binder.

The anode layer includes at least one of a lithium metal and a lithium alloy as anode active material. Examples of the metal element other than lithium included in the lithium alloy include Mg, Ag, In, Sn, Si, Ga, Au, and Pt.

The anode layer may further include, for example, a carbon-based active material, an oxide-based active material, a Si based active material, and the like in addition to the lithium metal and the lithium alloy as anode active material.

Examples of the carbon-based active material include graphite, hard carbon, and soft carbon.

Examples of the oxide-based active material include lithium titanate.

Examples of Si active material include Si alone, Si alloy, and silicon oxide.

Examples of the form of anode active material include particulate. The mean particle size of anode active material grains is not particularly limited, and may be in 1 nm of 100 micrometers.

Examples of the conductive material, the solid electrolyte, and the binder used in the anode layer include the same materials as those exemplified as the conductive material, the solid electrolyte, and the binder that may be included in the cathode layer.

The thickness of the anode layer may be 0.1 μm or more and 100 μm or less.

### [Anode Current Collector]

The material of anode current collector may be a material that does not alloy with Li, and may include, for example, SUS, copper, nickel, and the like. Examples of the form of anode current collector include a foil shape and a plate shape. The shape of anode current collector in plan view is not particularly limited, and examples thereof include a circular shape, an ellipse shape, a rectangular shape, and an arbitrary polygonal shape. In addition, the thickness of anode current collector varies depending on shapes, but may be, for example, in a range of 1 μm to 50 μm or in a range of 5 μm to 20 μm.

### [Solid Electrolyte Layer]

The solid electrolyte layer includes a solid electrolyte, and optionally includes a binder or the like.

Examples of the solid electrolyte include the solid electrolytes that can be contained in the cathode layer described above. When two or more kinds of solid electrolytes are used, two or more kinds of solid electrolytes may be mixed, or two or more solid electrolytes may be formed into a multilayer structure.

The proportion of the solid electrolyte in the solid electrolyte layer is not particularly limited, but may be, for example, 50% by mass or more and 99% by mass or less.

Examples of the binder include binders that can be contained in the cathode layer described above.

When the solid electrolyte layer contains a binder, the content of the binder may be 0% by mass to 10% by mass with respect to the total amount of the solid electrolyte layer.

The filling rate of the solid electrolyte layer may be 82.3% or more and may be 89.7% or less. When the filling rate of the solid electrolyte layer is 82.3% or more, the voids are small, which contributes to suppression of a short circuit of the solid-state battery.

The filling rate of the solid electrolyte layer indicates the volume excluding the voids inside the solid electrolyte layer with respect to the total volume of the solid electrolyte layer.

The filling rate of the solid electrolyte layer can be calculated by determining the ratio of the volume calculated from the specific gravity of the material to the actual volume of the solid electrolyte layer.

The thickness of the solid electrolyte layer may be 65 μm or more from the viewpoint of suppressing a short circuit of the solid-state battery, may be 100 μm or less from the viewpoint of reducing the resistance of the solid-state battery, or may be 77 μm or less.

The solid electrolyte layer can be formed, for example, by the following method.

A solid electrolyte slurry containing a solid electrolyte, a binder, and a solvent may be prepared, and a solid electrolyte slurry may be applied on a release film to form a solid electrolyte layer.

Examples of the solvent include a solvent that can be used for preparing cathode slurry described above.

### 2. Solid-State Battery Production Method

A method for producing a solid-state battery comprising a cathode layer, an anode layer, and a solid electrolyte layer disposed between the cathode layer and the anode layer,
the method comprising:
obtaining a stack by disposing the solid electrolyte layer between the anode layer and the cathode layer, and
vacuum-sealing the stack with a laminate film and pressing them,
wherein the anode layer comprises at least one of a lithium metal or a lithium alloy;
wherein a ratio of a thickness of the solid electrolyte layer to a thickness of the anode layer is 0.65 or more and 0.77 or less; and
wherein a filling rate of the solid electrolyte layer is 82.3% or more.

The step of obtaining a stack is a step of obtaining a laminate in which the solid electrolyte layer is disposed between cathode layer and anode layer.

Cathode layer, anode layer, and the solid electrolyte layer used in the step of obtaining the stack may be the same as those exemplified in the above-described solid-state battery.

In the step of obtaining the stack, a solid electrolyte layer may be disposed on one of cathode layer and anode layer, and the solid electrolyte layer may be pre-pressed. Cathode layer and the second electrode of anode layer may be disposed on the solid electrolyte layer to obtain a stack. The press method and the press pressure of the pre-press may be the same as the press method and the press pressure in the press step described later.

The pressing step is a step of vacuum-sealing the stack to a laminate film and pressing the laminate.

The pressing pressure for pressing the stack in the pressing step is not particularly limited, but may be greater than the pressing pressure in the pre-pressing, and from the viewpoint of suppressing the short circuit of the solid-state battery, the pressing pressure may be 400 MPa or less, or may be 300 MPa or less.

The pressing method is not particularly limited, and examples thereof include a cold isotropic press and a roll press.

Depending on the pressing in the pressing step, the solid electrolyte contained in the solid electrolyte layer is less likely to be deformed. Therefore, the solid electrolyte contained in the solid electrolyte layer after the pressing and the solid electrolyte contained in the solid electrolyte layer before the pressing can be regarded as the same.

### EXAMPLES

### Example 1

### [Preparation of Cathode]

As cathode active material, a predetermined sulfur mixture was used.

Using butyl butyrate as the solvent, the sulfur mixture, the binder, and the conductive material were blended so as to have a mass-composition ratio of the sulfur mixture:binder:conductive material=64.8:0.3:34.9, thereby preparing a cathode slurry.

The resulting cathode slurry was then coated onto an aluminium foil as a cathode current collector with a coating gap of 200 micrometers. Thereafter, the obtained coating film was temporarily dried at 50° C. for a predetermined time, and dried at 100° C. for 1 hour to obtain a cathode having 7.8 mg/cm² basis weight and 5.84 mAh/cm² of designed capacitance formed on a cathode current collector.

### [Preparation of Solid Electrolyte Layer]

Particles of sulfide solid electrolyte having a mean particle size (D50) of 0.5 μm were used as the solid electrolyte.

Using butyl butyrate as a solvent, the sulfide solid electrolyte and the binder were blended so as to have a mass composition ratio of sulfide solid electrolyte:binder=90.9:9.1, to obtain a solid electrolyte slurry.

The solid electrolyte slurry was then coated on the release film with a coating gap of 300-800 μm.

Thereafter, the obtained coating film was temporarily dried at room temperature for about 3 hours, and dried at 165° C. for 1 hour.

Two coated foils of diametric 14.5 mm were punched out from the dried coated foil, and the coated surfaces of the two coated foils were superimposed and pressed by a 1t. After the pressing, the release film was peeled off to obtain a self-supporting solid electrolyte layer. The thickness of the solid electrolyte layer was 62 μm, and the filling rate was 89.7%.

### [Preparation of Anode]

As anode active material, a Li—Mg alloy foil having a thickness of 100 micrometers was used. A Ni foil was used as anode current collector. Li—Mg alloy foil was punched with a diameter 13.0 mm and Ni foil was punched with a diameter 14.5 mm, and a anode layer made of a Li—Mg alloy foil was formed on anode current collector to obtain a anode in which a anode layer was formed on anode current collector.

### [Preparation of Solid-State Battery]

The prepared cathode was punched with a diametric 11.28 mm, and a self-supporting solid electrolyte layer of the prepared diametric 14.5 mm was placed between cathode and the prepared anode to obtain a stack body, and the laminated body was vacuum-sealed in an exterior body made of a laminated film to which a cathode terminal and an anode terminal were attached, using Al as a cathode terminal and Ni as a anode terminal, respectively, to obtain a cell. Sealed cell was isotropically pressed with 300 MPa using CIP (cold isotropic pressing) to produce laminated cell, which is a solid-state battery.

### Example 2

A solid-state battery was prepared in the same manner as in Example 1 except that a solid electrolyte layer having a thickness of 77 μm and a filling rate of 82.3% was used.

### Comparative Example 1

A solid-state battery was prepared in the same manner as in Example 1, except that a anode layer having a thickness of 150 μm and a solid electrolyte layer having a thickness of 55 μm and a packing ratio of 94.2% were used.

### Comparative Example 2

A solid-state battery was prepared in the same manner as in Example 1 except that a solid electrolyte layer having a thickness of 54 μm and a filling rate of 95.9% was used.

### Comparative Example 3

A solid-state battery was prepared in the same manner as in Example 1 except that a solid electrolyte layer having a thickness of 105 μm and a filling rate of 66.7% was used.

### [Yield Evaluation During Cell Preparation]

When any number (10 to 30) of the solid-state batteries of Examples 1 to 2 and Comparative Examples 1 to 3 were manufactured, the presence or absence of a short circuit was evaluated, and the yield of the solid-state batteries evaluated as having no short circuit was calculated.

The evaluation criteria were as follows: yield less than 40% was rated as −, 40-90% was rated as +, and over 90% was rated as ++.

The results are given in Table 1.

TABLE 1

| | | | Solid | Solid | |
|---|---|---|---|---|---|
| | | Solid | electrolyte | electrolyte | |
| | Anode | electrolyte | layer/anode | layer | |
| | layer | layer | layer | filling | |
| | thickness | thickness | thickness | rate | |
| | [μm] | [μm] | ratio | [%] | Yield |
| Comparative | 150 | 55 | 0.37 | 94.2 | − |
| Example 1 | | | | | |
| Comparative | 100 | 54 | 0.54 | 95.9 | + |
| Example 2 | | | | | |
| Comparative | 100 | 105 | 1.05 | 66.7 | − |
| Example 3 | | | | | |
| Example 1 | 100 | 65 | 0.65 | 89.7 | ++ |
| Example 2 | 100 | 77 | 0.77 | 82.3 | ++ |

As shown in Table 1, when the ratio of the thickness of the solid electrolyte layer to the thickness of the anode layer is 0.65 or more and 0.77 or less, and the filling rate of the solid electrolyte layer is 82.3% or more, the yield of the solid-state battery without a short circuit exceeds 908, and it can be seen that the short circuit can be suppressed as compared with the case where the above condition is not satisfied.

### REFERENCE SIGNS LIST

10 Cathode layer
20 Solid electrolyte layer
30 Anode layer
100 Solid-state battery

The invention claimed is:

1. A solid-state battery,
wherein the solid-state battery comprises a cathode layer, an anode layer, and a solid electrolyte layer disposed between the cathode layer and the anode layer;
wherein the anode layer comprises at least one of a lithium metal or a lithium alloy;
wherein a ratio of a thickness of the solid electrolyte layer to a thickness of the anode layer is 0.65 or more and 0.77 or less; and
wherein a filling rate of the solid electrolyte layer is 82.3% or more.

2. The solid-state battery according to claim 1, wherein the thickness of the anode layer is 100 μm or less.

3. The solid-state battery according to claim 1, wherein the thickness of the solid electrolyte layer is 65 μm or more.

4. A method for producing a solid-state battery comprising a cathode layer, an anode layer, and a solid electrolyte layer disposed between the cathode layer and the anode layer,
the method comprising:
obtaining a stack by disposing the solid electrolyte layer between the anode layer and the cathode layer, and
vacuum-sealing the stack with a laminate film and pressing them,
wherein the anode layer comprises at least one of a lithium metal or a lithium alloy;
wherein a ratio of a thickness of the solid electrolyte layer to a thickness of the anode layer is 0.65 or more and 0.77 or less; and
wherein a filling rate of the solid electrolyte layer is 82.3% or more.

5. The method for producing the solid-state battery according to claim 4,
wherein a pressing pressure of the pressing is 400 MPa or less.
